(19) United States
(12) Patent Application Publication
(10) Pub. No.: US 2007/0264465 A1
(43) Pub. Date: Nov. 15, 2007

(54) Method for the Production of a Web of Insulating Material Made of Mineral Fibres and Web of Insulating Material

(75) Inventor: Gerd-Rudiger Klose, Dorsten (DE)

Correspondence Address: JONES & SMITH, LLP, THE RIVIANA BUILDING, 2777 ALLEN PARKWAY, SUITE 800, HOUSTON, TX, 77019-2141, US

(73) Assignee: Deutsche Rockwool Mineralwoll GmbH & Co. OHG

(21) Appl. No.: 10/587,963

(22) PCT Filed: Dec. 18, 2004
(86) PCT No.: PCT/EP04/14449

§ 371 Date: Jun. 7, 2007

(30) Foreign Application Priority Data
Jan. 31, 2004 (DE) 10 2004 004 954.8
Sep. 29, 2004 (DE) 10 2004 047 193.2

(51) Int. Cl. B32B 3/02; B29D 31/00

(52) U.S. Cl. 428/74; 264/147

(57) ABSTRACT

The invention relates to a method for the production of a web of insulating material made of mineral fibres, wherein the mineral fibres are made from a melt and are deposited on to a conveyor as a primary non-woven material; the primary non-woven material is dangled at right angles in relation to the longitudinal extension thereof and is deposited as a secondary non-woven material onto a second conveyor, the secondary non-woven material is then displaced in such a way that the mineral fibres extend at right angles in relation to the large surfaces of the secondary non-woven material and the secondary non-woven material is divided into at least two webs of insulating material by means of a separating cut parallel to the large surfaces of the secondary non-woven material, said webs of material respectively comprising a large surface and a separating surface which has substantially the same area as the large surface and which is arranged opposite said large surface. In order to improve a generic method for the production of a web of insulating material made from mineral fibres such that the web of insulating material can better exhibit or more easily exhibit characteristics such as resistance and. processability, particularly in the field of external building surfaces and covering surfaces of pipelines, a coating is applied to at least one of the separating surfaces of the two webs of insulating material.

This invention relates to a method for the production of a web of insulating material made of mineral fibres, in particular from rock wool and/or glass wool, wherein the mineral fibres are made from a melt and are deposited onto a conveyor as a primary non-woven material, the primary non-woven material is dangled at right angles in relation to the longitudinal extension thereof and is deposited as a secondary non-woven material onto a second conveyor, the secondary non-woven material is then displaced in such a way that the mineral fibres extend at right angles to the large surfaces of the secondary non-woven material and thereafter the secondary non-woven material is divided into at least two webs of the insulating material by means of a separating cut parallel to the large surfaces of the secondary non-woven material, said webs of material respectively comprising a large surface and a separating surface which has substantially the same area as the large surface and which is arranged opposite said large surface. The invention further relates to a web of insulating material from fibres which are bound with a bonding agent, in particular from rock wool and/or glass wool, and having a large surface and a separating surface which is produced when a secondary non-woven material is divided into two webs of the insulating material, wherein the mineral fibres in the region of said separating surface are arranged at right angles to said separating surface and in the region of the surface deviating at angle of 90° in relation to the large surface, in particular extending parallel to the large surface, and having a lamination.

Insulating materials from vitreously solidified mineral fibres are classified in the commerce according to their chemical composition in glass wool and rock wool insulating materials. Both varieties are different from each other by the chemical composition of the mineral fibres. Glass wool fibres are produced from siliceous melts containing high fractions of alkalies and boroxides which act as a fluxing agent. These melts have a vast processing range and can be drawn into relatively smooth and long mineral fibres by means of rotating bowls, of which the walls include holes, and said fibres are mostly bound at least partially with compounds of thermosetting phenolformaldehyde and urea resins. The fraction of these bonding agents in the glass wool insulting materials amounts to approx 5 to approx 10 weight percent for example and has an upper limit also by the fact that the character of a non-combustible insulating material should be maintained. The bonding Can be also effected with thermoplastic bonding agents like polyacrylates. The fibre mass is added further materials like for example oils in amounts less than approximately 0.4 weight-%, for hydrophobing and dust-laying. The mineral fibres which have been impregnated with bonding agents and other additives are collected as a web of fibres on a conveyor moving at a low speed. Mostly, the mineral fibres from several defibring units are deposited one after another onto this conveyor. During this, the mineral fibres in a plane are mostly oriented lacking a sense of direction. However they are supported extremely flat on top of each other. By a slight vertical pressure the web of fibres is compacted for the desired thickness and simultaneously for the required bulk density through the conveying speed of the conveyor, and the bonding agents are hardened by means of hot air in a hardening furnace, so that the structure of the web of fibres becomes fixed.

During the production of rock wool insulating materials impregnated mineral fibres are collected if possible as a thin and light-weight now-woven mineral fibre material, a so-called primary non-woven material, and are moved away at a high speed from the region of the defibring unit, to keep the amount of required cooling agents low which otherwise would have to be removed again from the fibrous web with additional energy consumption during the progress of the production process. From the primary non-woven material an endless fibrous web is built up which exhibits a uniform distribution of the mineral fibres.

Said primary non-woven material consists of relatively coarse fibre flakes having higher bonding agent concentrations in their core zones, whereas mineral fibres which are bound more weakly or not at all are predominant in the rim areas. The mineral fibres are oriented in said fibre flakes approximately in the transport direction. Rock wool insulating materials have a bonding agent content of approx 2 to approx 4.5 weight-%. Compounds of phenolic, formaldehyde and urea resins are predominantly used as bonding agents A part of the resins is also substituted already for polysaccharides. As it is the case with glass wool insulating materials, inorganic bonding agents are used only for special applications of the insulating materials, since the same are clearly more brittle than organic bonding agents, of which the reaction mostly ranges from elastic to plastic, which fact complies with the requirements to the nature of mineral fibre insulating materials as resilient building materials. As additives mostly high-boiling mineral oils in proportions of 0.2 weight-% and exceptionally also 0.4 weight-% are used.

Normally, said primary non-woven materials are deposited transversely over and onto a further conveyor, by means of a conveyor which is suspended for an oscillating movement, whereby it is possible to produce an endless web of fibres consisting of a plurality of diagonally superposed individual layers. By an upsetting operation directed horizontally in the conveying direction and simultaneously vertically said web of fibres can be folded more or less intensively. The axes of the main folding direction are horizontally aligned and thus extend transversely to the conveying direction.

The forces acting upon said fibrous web lead to that core zones which are high in bonding agent are compacted into narrow segments and are pleated, resulting in main folds with folds in flanks. At the same time, mineral fibres which are less bound or which are free of bonding agent are slightly rolled in the gussets of the folds and between the narrow segments and are thus slightly compressed. The fine structure therefore consists of relatively stiff segments which exhibit a certain flexibility due to their numerous folds, but which are relatively stiff parallel to the folding axes and form intermediate spaces which are easily compressible. By pleating and warping, the resistance to pressure and the transverse tensile strength of the web of fibres substantially increase compared to a normal and, in particular, flat arrangement of the mineral fibres. The bending strength of the web of fibres or the sections separated there from in the form of boards and insulating felts accordingly is considerably higher in the transverse direction than in the production direction. In the case of roof insulating panels having a bulk density of approx 130 to 150 kg/m³ the bending strength in the transverse direction is three to four times as high as the bending strength in the production direction.

This dependency of the mechanical properties of the orientation of the mineral fibres in the insulating material is utilized for the manufacture of products which are called segments for segmental plates and commercially available segmental webs.

Said segments are mostly 200 mm wide insulating elements which are cut from a correspondingly thick web of fibres in the production direction. Here, the mineral fibres in the web of fibres or in the particularly rigid segments are oriented at right angles to the cutting surfaces which are now the large surfaces of the segments. Segments with bulk densities of more than 75 kg/m³ can be used therefore as a tension and pressure-resistant insulating layer on external walls of buildings and can be pasted to said external wall and thereafter covered with a reinforced plaster skin. Such an insulation is called a thermal insulation composite system. The pressure-resistant segment is sufficiently flexible in the longitudinal direction for being pasted also to curved building parts. At the same time it is still compressible at right angles to the lateral surfaces to an extent such that by exerting little pressure deviations from the respective length and width (dimensional tolerances) between the individual segments may be compensated for, thereby producing insulating layers with tightly sealed joints. Several segments are further assembled to segmental plates.

Segmental plates within a bulk density range of approx 30 to approx 100 kg/m³ and preferably <60 kg/m³ are separated at a desired material thickness in the production direction as segments from a web of fibres having a thickness of between approx 75 to 250 mm, which segments are pasted flatly and transversely onto a closed supporting material such as aluminum, aluminum composite, lattice-reinforced aluminum-polyethylene composite foils and similar foils or onto paper webs for example. During this, the individual segments are pressed against each other only under a low pressure and do mostly not form a closed insulating layer. To have, for reasons of fire protection, as little combustible substance as possible within said segmental plate, the specific amounts of e.g. dispersion binder are very small. A technique which is even more simple is connecting for example aluminum-polyethylene composite foils to the surface of the segments by heating said polyethylene foil which is frequently only approx 0.03 to approx 0.06 mm thick.

In a similar way also segmental plates from glass wool fibre webs with fibres extending at right angles to the large surfaces may be produced. The smooth mineral fibres are arranged in said segmental plates extremely parallel to each other and are easily compressible with respect to lateral forces, especially as the bulk densities are generally smaller than those of segmental plates made from rock wool insulating materials.

Moreover, from segments webs of segments may be produced having widths of e.g. 500 mm or 1000 mm, thicknesses of approx 20 mm to approx 100 mm as well as lengths of several metres. Due to the orientation of the mineral fibres at right angles to the large surfaces, level surfaces of huge ventilating ducts for example may be provided with a level and relatively rigid insulating layer. At the same time, due to their compressibility in the direction of the width of the segments, i.e. in the longitudinal direction of the webs of segments, webs of segments may be easily passed around small-diameter conduits, forming a uniform jacket there. This behaviour is even more favoured by the joints between the individual segments, since the transverse bracing of the insulating material is interrupted here.

Webs of segments and segmental plates having a small width allow higher deformation under constant application of force than webs of segments and segmental plates having a larger width. The bending radius possible of these insulating elements decreases with an increasing insulating thickness. The compression of the inner zones of the web of fibres increasing with a decreasing bending radius naturally leads to a considerable compaction, but also to an increase in the resistance to pressure in these zones. Therefore, in the same manner as rigid pipe shells which are however more complicated to manufacture, webs of segments are suited as a supporting layer for forming the shell of pipelines, for example with smooth or profiled metal sheets from aluminum or steel, plastic foils, plaster or mortar layers The mineral fibres which are oriented at right angles or in the case of pipelines radially to the insulated surfaces lead to an increase in the thermal conductivity of the insulating materials compared to those insulating materials which have a laminar fibre structure or compared to pipe shells in which the mineral fibres are arranged concentrically about the centre line of the pipeline.

The production of segments requires complicated techniques and results in a lower speed of passage through the production line. Also, the bonding technique is substantially unsuitable for the segments that partly have a high weight A connection by bonding between adjacent segments may be weakened by the fact that loose mineral fibres or mineral fibre fragments (dust) are present in the region of the bonding surfaces.

Webs of segments are tightly rolled up for storage and transport and are wrapped with a cover. During this, the segments are subject to strong shearing forces at the beginning and at the end of a roll. After unrolling the segments come off easily. The segments are even catapulted away when the web of segments is allowed to unroll itself after the removal of the cover, due to the high restoring forces. During this uncontrolled unrolling action the end of the roll is catapulted through the air like a whip, so that segments which have already partly peeled will be fully peeled due to the acceleration or the high impact against the ground.

Further there is a risk that individual segments peel off the web of segments when the segments are inadvertently outwardly folded. Since the strength of the connection of the segments is a priori insufficient, supporting layers which are pasted to the segments only partially do mostly not come into question, and among those are for example woven glass fibre nettings or similar two-dimensional structures.

From the aspect of processing, the segmental plates which are pasted-on as individual elements have the advantage that necessary separating cuts can be made along the transverse joints between adjacent segments or the same can be used at least as a subsidiary line for guiding the cutting tool. The transverse joints can be further marked as a folding position on the supporting layer, in order to suitably adapt the segmental plates with respect to their size to the installation conditions by folding the segments down.

A much more economic process for manufacturing insulating materials with an orientation of the mineral fibres which is characteristic of segments, segmental plates or segmental webs is described in EP 0 741 827 B1. In this method a thin primary non-woven material is folded/pleated by a conveyor which moves up and down and is placed onto a second conveyor in an endless and loop-like fashion, thereby producing individual layers which are pressed against each other in the horizontal direction and which are upset to a different extent, depending on the desired bulk density. To this end, said primary non-woven material is guided between two pressure-resisting belts which first of all only limit the height of said primary non-woven material. This alone already causes the mineral fibres in the webs of said primary non-woven material which are turned round in a curved fashion to be oriented parallel to the limiting surfaces. In order to obtain as far as possible level surfaces said primary non-woven material can be upset also in the vertical direction.

This orientation of the mineral fibres in the primary non-woven material can be effected in a separate device, but most expediently it is effected in connection with a hardening furnace In said hardening furnace hot air flows vertically through the endless web of fibres between two pressure belts, at least one thereof being movable in the vertical direction. Said pressure belts include pressure-resisting elements with holes, with parts of the surface of the web of fibres being pressed into said holes, whereby the surfaces are profiled. In both surfaces of the web of fibres a further orientation of the mineral fibres, a further compaction with respect to the underlying regions and eventually a slight enrichment of bonding agent may take place.

With the aid of the heat energy transmitted through the hot air said web of fibres with the bonding and impregnating agents contained therein is heated, so that humidity present in the web of fibres is expelled and the bonding agents are hardened by forming interconnecting films or solid bodies. After the fixing of the web of fibres through the hardening of the bonding agents a structure shows itself in the longitudinal section in which the mineral fibres in the core of the primary non-woven material are predominantly oriented at right angles to the large surfaces of the endless web of fibres. In the regions close to the surface the mineral fibres are oriented parallel to the large surfaces. Because of the relatively high stiffness of the core of the primary non-woven material the mineral fibres may be upset also in a mushroom fashion and/or may be pressed downwardly between the zones with mineral fibres that are oriented at right angles to the large surfaces, if the vertical pressures are correspondingly high. Between the webs of primary non-woven material which are turned around in a curved fashion, there are generally left small gussets which occur as differently wide and differently deep transverse channels in the two large surfaces of the endless web of fibres.

In the horizontal section the more strongly compacted zones having the mineral fibres extending at right angles to the large surfaces are dearly different from the intermediate zones with a flat arrangement of the mineral fibres. In cross-section the structure is less uniform than in insulating panels which are used for making segments So the bending tensile strength for example is lower at a comparable bulk density, due to the inhomogeneity.

The mineral fibres lying flatly in the zones near the surface clearly reduce the thermal conductivity at right angles to the large surfaces. From the document EP 1 321 595 A2 it is known that the transverse tensile strength between these mineral fibres is badly developed, so that these flat-lying mineral fibres are removed, in order to obtain stronger connections of the insulating materials produced therefrom for example to coatings for the production of sandwich elements or at the use as plaster supporting structures in thermal insulation composite systems.

However, since dependent on the compaction in the region of the two large surfaces the zones which are close to the surface extend up to depths of approx 15 mm to approx 35 mm into the web of fibres, removal thereof causes considerable material losses, if the zones Which are cutoff are not themselves used as insulating materials. Such coupled productions are considered as difficult and are avoided, if possible.

From EP 0 741 827 there is further known the production of sheet-lined insulating felts, in which the endless loop-like folded web of fibres is bonded on both large surfaces to supporting layers from aluminum foils and in which the web of fibres is thereafter cut open centrally and parallel to the large surfaces thereof, so that finally two equally thick and laminated webs of fibres are produced which are subsequently rolled up. The webs of fibres which are produced in this way and which are designated as insulating felts only allow partial bonding to the supporting layer. This partial bonding and the low transverse tensile strength result in a composite structure with only a low stability, of which the connection is considerably less strong compared to a segmental plate or a segmental mat composed of segments However, this difference is not important in a continuously bonded web of fibres, especially regarding the peeling of the supporting layers on the two ends. However, the compressible zones having no sheet-lining and positioned on the outside lead to reliefs.

The document EP 0 867 572 A2 further describes an insulating element made from mineral fibres which consists of a web of mineral fibres and/or several interconnected segments and at least one lamination in the form of a foil applied to a major surface. This insulating element accordingly consists of thin uniform web of fibres from flatly superposed and interconnected individual fibres with a material thickness of less than 15 mm as well as a lamination and several interconnected segments. The lamination may be applied to both the thin web of fibres and the segments.

From the document DD 248 934 A3 and the document EP 1 152 094 A1 cited therein as prior art as well as from the document DE 197 58 700 C2 methods are known in which a web of fibres that is impregnated with bonding agents and other additives is divided into segments which are turned by 90° and thereafter pressed against each other horizontally and upset vertically, so that segmental webs are produced. It is also provided that the individual segments are differently compacted and formed from different materials. After the assembly of the individual segments the mineral fibres are oriented more or less at right angles to the large surfaces, dependent on the orientation in the original web of fibres. Due to the non-avoidable vertical pressure, the mineral fibres present in the two zones close to the surface are folded over and, also in this case, are fixed in a flat position.

In the methods described in EP 0 741 827 B1 and also in DD 248 934 A3 the stability may be increased by the fact that while passing the hardening furnace the respective uppermost and only some micrometres to millimetres thick zone of the web of fibres is more strongly compacted and enriched with bonding agents than the immediately underlying zones, whereby a stronger contact with the lamination can be produced, although the transverse tensile strength of the web of fibres which is decisive for the use is predominantly influenced by the zones which are arranged more deeply.

Starting from the above-described prior art It therefore is an object of the present invention to improve a generic method for the production of a web of insulating material made of mineral fibres such that the web of insulating material to be produced can better exhibit or more easily exhibit characteristics such as stability and processability, particularly in the field of external building surfaces and covering surfaces of pipelines. Moreover, it is an object of the invention to provide a generic web of insulating material made of mineral fibres which are bound with a ending agent, which web of insulating material exhibits characteristics such as improved processability and also improved stability as well as further characteristics of segments or segmental webs or segmental plates with at least equal quality.

The solution of this object provides in a generic method that a lamination is applied to at least one of the separating surfaces of the two webs of insulating material. The solution of the object in a web of insulating material according to the invention provides that the lamination is arranged on the separating surface. The webs of insulating material according to the invention produced by a method according to the invention shall exhibit if possible characteristics corresponding to the basic characteristics of segmental plates.

Therefore, according to the invention, the lamination is not applied to the compressible, weakly bound regions of the web of insulating material, but to the separating surfaces resistant to transverse tension and to pressure, namely in regions having mineral fibres oriented at right angles to said lamination. Compared thereto, the surfaces arranged opposite the separating surfaces are compressible in the direction of their surface normal and are accordingly able to adapt to irregularities of the surface to be insulated, such as the facade of a building, while the separating surfaces with the lamination which are then positioned on the outside remain extremely smooth. With such webs of insulating material there can be insulated for example also flanges of ventilation ducts, sleeves or clamps in pipelines up to a certain level, without this having any influence on the formation of the external surfaces of the thermal insulation. Therefore, flanges of ventilation ducts, sleeves or clamps in pipelines can be overlapped by a corresponding web of insulating material in such a way that the external surface does not exhibit any reliefs.

The folds caused by the primary folding/pleating of the primary non-woven material can act as a buckling or bending portion, whereby the surface of the web of insulating material which is arranged on the inner side more easily adapts to the round surface of the area to be insulated which is arranged on the outer side, corresponding to a draft of traverse.

In the case of webs of insulating materials for external wall surfaces of an aerated lining which are used for example in the form of insulating felts or insulating boards adapted for being rolled up and also in the core insulation behind an external brickwork shell, considerable economical advantages result from the compressibility of the web of insulating material with regard to the processing and mounting of the web of insulating material according to the invention.

Supplementary it may provided in the method according to the invention that the mineral fibres which in the large surfaces extend substantially parallel to the large surfaces are removed. Accordingly, also the large surfaces are processed in such a way that in said large surfaces a fibre orientation substantially at right angles to these large surfaces predominates. By this further development of the method according to the invention the thickness of the web of insulating material can be adjusted on one side and on the other side the stability characteristics can be changed such that also the large surfaces of the web of insulating material are sufficiently resistant to pressure. A web of insulating material formed in this way is similar in its characteristics to the basic characteristic of a segmental mat. The removal of the mineral fibres extending substantially parallel to the large surfaces additionally has the effect that an optically aesthetic and in particular a smooth large surface is produced.

The web of fibres which according to the invention is finally divided into at least two webs of insulating material includes mineral fibres bound with bonding agents, which web of fibres is in case impregnated through waterproofing and/or antidust agents or other additives and is formed endlessly. In the interior of the web of fibres and up and into the regions close to the surface, the mineral fibres are oriented at right angles to the large surfaces of the web of fibres positioned on the outside. Below said two large surfaces of the web of fibres which are positioned on the outside the mineral fibres are oriented in decreasing angles until being parallel to the large surfaces. In the regions of said large surfaces the mineral fibres may have a higher density and may be bound with additional bonding agents.

Prior to forming webs of insulating material and before a hardening furnish, the web of fibres can be ripped up by the separating cut made parallel to the large surfaces of the web of fibres or the secondary non-woven material. The separating cut can be made centrally but also off centre, so that either two webs of insulating material having the sane material thickness or webs of insulating material having a different material thickness can be produced. By the separating cut the separating surfaces are formed to which air-permeable and/or heat-resistant non-wovens, wovens and/or two-dimensional structures are applied. These above-mentioned laminations can consist for example of glass, natural and/or organic chemical fibres. The chemical fibres can be formed for example from carbon, aramide, terephthalate, polyamide or polypropylene fibres or mixtures of these above-mentioned chemical fibres.

Preferably, the laminations are tension-resistant, web-like laminations that are formed in one or several layers. If the lamination comprises several layers the same may be formed form different fibres, in particular, glass fibre tangled non-wovens for example may be connected to tangled non-wovens from thermoplastic fibres or to perforated foils made of thermoplastic materials.

According to a further feature of the invention it is provided that the tension-resistant web-like laminations are bonded to the web of insulating material, for which purpose hot-melt bonding agents turned out as suitable bonding agents which are applied to the lamination and/or the separating surface in the form of fines and/or dots.

In addition to the above-mentioned effects said laminations may also serve as external reinforcement, protection, filter and/or decorative layers.

For carrying out the method according to the invention it turned out as advantageous to arrange the laminations in the form of rolls in the region between the two webs of insulating material produced after the separating cut and to feed them to the separating surfaces of the webs of insulating material, before the laminations and webs of insulation material thus interconnected are rolled up, wherein said lamination is arranged in said roll on the inside thereof.

During the separation of the web of fibres into the partial webs that are to be sheet-lined, namely into the webs of insulating material, the holding capacity of the bonding agents contained in the web of fibres may be affected or reduced. To prevent this negative influence, the bonding agents contained in the web of fibres can be activated for example by means of solvents, particularly solvents like water To this end, the webs of insulation materials are passed over contact rollers, by means of which they are wetted with the solvent. Alternatively or supplementary, additional bonding agents may be sprayed preferably in small amounts onto the surfaces and the separating surfaces of the webs of insulating material.

Alternatively, it may be provided that the lamination includes at least on one side, namely at least on the surface facing the separating surface, a thin layer of for example a highly viscous dispersion binder or for example a water-silicate-plastic adhesive filled with pigments, which layer is arranged as an impregnation. A precondition is that the lamination has a sufficient material thickness in order to be able to support this thin layer. Of course, other adhesives can be used as well, provided that they have a viscosity which makes it possible for the adhesive not to be absorbed by the webs of insulating material which are frequently absorbing through capillary action, so that thereafter said webs of insulating material become saturated with these adhesives up to the level of brittle fracture. These negative effects show themselves for example at the impregnation of glass fibre tangled webs or glass fibre wovens with duroplastic resins which thereafter are applied to the separating surface of the web of insulating material and are supplied to a hardening furnace together with the web of insulating material for hardening the binder. At the use of a highly viscous dispersion binder or of a water-silicate-plastic adhesive filled with pigments as well as at the use of a comparable adhesive, a bonding of the lamination to the separating surface over the full area thereof is possible, since the lamination prevents the intrusion of single mineral fibres in a perforation of a pressure band of the hardening furnace and hence the formation of a surface embossing. Furthermore, no additional devices are needed for the hardening of the adhesive, thereby reducing the energy required for the hardening of the adhesive.

The two webs of insulating material formed of the secondary non-woven material may be brought together with the laminations applied to the respective separating surfaces before the hardening furnace and passed together through the hardening furnace in which the bonding agents of the secondary non-woven material and the adhesive between the lamination and the separating surface are hardened by means of hot air. Thereafter the webs of insulating material thus formed can be trimmed in the longitudinal direction and cut to the desired length, with the cutting operation either producing lengths allowing the web of insulation material to be rolled up or shorter lengths for forming insulation boards. The insulating materials, e.g. from rock wool, made from said webs of insulating material have bulk densities of between 23 kg/m³ and 70 kg/m³, while corresponding webs of insulating material from glass wool have bulk densities in a range between 12 kg/m³ and 55 kg/m³.

According to the above-described embodiment said secondary non-woven material is divided into webs of insulating material before the hardening furnace, and said webs of insulating material are provided with laminations on the corresponding separating surfaces before the hardening furnace. Alternatively, it may be provided that the secondary non-woven material is divided into the webs of insulating material only after having passed through the hardening furnace, and consequently said webs of insulating material are also provided with said lamination only after having passed through the hardening furnace. In this case, the secondary non-woven material is given its final structure prior to being divided into the webs of insulating material by allowing the bonding agent to harden in the hardening furnace. The separating cut is carried out by means of a belt saw, with sawing dust that occurs directly in the region of the belt saw being extracted, so that the same will not adhere to the separating surface and negatively influence the bonding of the lamination to the web of insulating material.

The bonding agent for bonding the webs of insulating material to the laminations is either applied to the separating surfaces of the webs of insulating material or directly to the lamination, unless the laminations have already been provided with a corresponding adhesive layer in the factory.

Apart from the air-permeable and heat-resistant laminations that have been already mentioned above also toils can be used as laminations.

For example, an aluminum-polyethylene composite foil is suited for a lamination for the above-mentioned purposes. In addition, this aluminum-polyethylene composite foil can be reinforced by two-dimensional glass-fibre nettings. During applying the lamination to the separating surface of the web of insulating material said polyethylene layer is heated by means of an idling heating roller, so that this polyethylene layer is softened and welded together with the tips of the mineral fibres of the web of insulating material.

In the method according to the invention it may be provided that the two webs of insulating material formed from said secondary non-woven material are identically formed, so that both webs of insulating material also carry identical laminations. But there also exists a possibility of forming said two webs of insulating material different from each other, especially with respect to the lamination thereof. It has already been pointed out above to that said two webs of insulating material have different material thicknesses when the separating cut is not made centrally. In addition, said two webs of insulating material produced from a secondary non-woven material may be differently formed also with respect to the nature and thickness of the lamination. Furthermore, there is a possibility of providing only one web of insulating material with a lamination, while the second web of insulating material is further processed, for example rolled up. Further, it is possible to roll up one web of insulating material carrying a lamination, while the second web of insulating material with or without lamination is divided into insulating boards. Of course, there is also a possibility of rolling up said one web of insulating material that is to be rolled up without a lamination, while the second web of insulating material is bonded to at least one lamination prior to it being divided into insulation boards.

According to a further feature of the invention it is provided that the laminations are trimmed on the rims thereof together with the webs of insulating material, so that said laminations terminate flush with said webs of insulating material.

At the use of webs of insulating material according to the invention for the insulation of pipelines the same are arranged on the pipeline with their narrow sides which extend in the direction of the longitudinal axis abutting each other, resulting in the formation of a complete pipeline insulation. The transition area of the joints of adjacent webs of insulating material can be covered in a simple way by means of self-adhesive foil strips, because the corresponding webs of insulating material exhibit sufficient stiffness which is otherwise given only in the case of segmental mats known from prior art. But said self-adhesive strips can also already be part of the lamination, provided that the same protrudes over a longitudinal edge portion of the web of insulating material If the web of insulating material according to the invention is formed in this way, it is particularly suited for the insulation of pipelines serving for transporting media, of which the temperatures are lower than the ambient temperatures. By this configuration the ingress of water steam can be reliably prevented, as far as the lamination is formed of composite foils acting as a vapour seal, of which a rim portion protrudes over a lateral surface that extends in the direction of the longitudinal axis of the web of insulating material, so that this rim portion can be bonded to the lamination of an adjacent web of insulating material.

In addition to a form of execution of a web of insulating material according to the invention having a rim portion of the lamination projecting on one side only, also a form of execution is conceivable in which said lamination projects over two rim portions which, in particular, extend parallel to each other. To facilitate the rolling-up of such a web of insulating material it may be provided that at least in the region of the projecting rim portion of the lamination a thin paper strip is rolled up along with the web of insulating material.

According to a further feature of the invention it is provided that the bonded laminations and in particular the bonded foils include markings. If the lamination is formed as an aluminum foil there may be provided regularly repeating embossings or markings applied with the aid of colours, for example in the form of bars or arrows. In this connection, it turned out as being sufficient when the markings are provided in both rim portions extending in the direction of the longitudinal axis of the web of insulating material and when they have a length of between 2 and 20 cm. Alternatively, said markings are arranged at intervals of 10 cm, so that said markings may be used as cutting aids during the cutting of the webs of insulating material. If the markings are provided in the form of arrows, the same may additionally indicate the direction of flow of a medium in a pipeline or in a ventilation duct.

In the case of correspondingly resistant laminations that include substances changing their colour if exposed to heat, for example bonding agents, said markings may be applied also with the aid of a laser beam.

Further features and advantages of the invention will become apparent from the following description of the attached drawing showing one embodiment of a device for carrying out the method for the production of a web of insulating material from mineral fibres. In the drawing it is shown by:

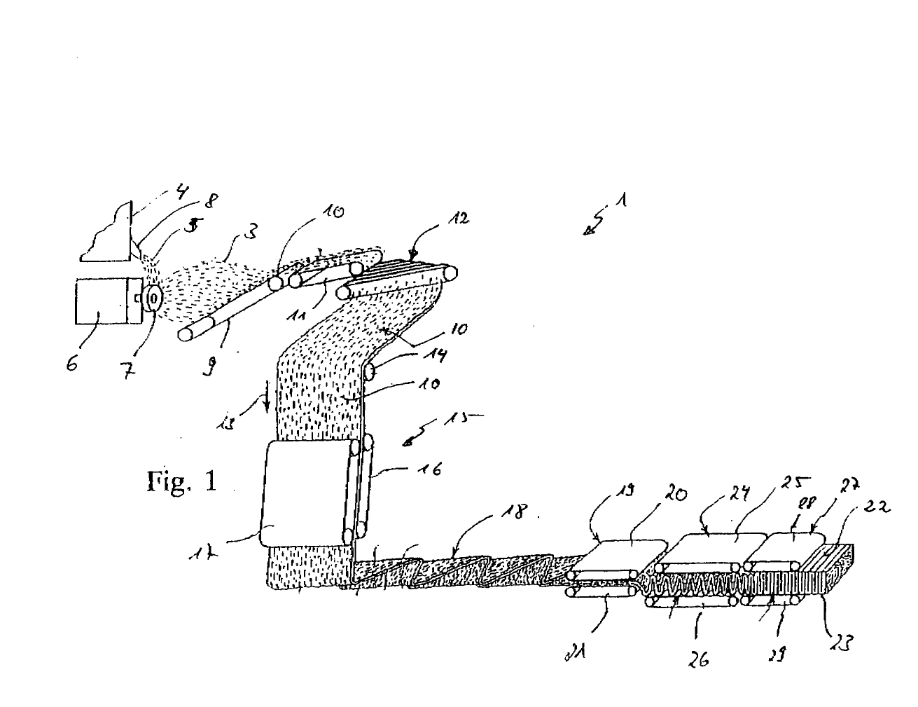

FIG. 1 a first section of a schematically illustrated device for the production of a web of insulating material from mineral fibres and

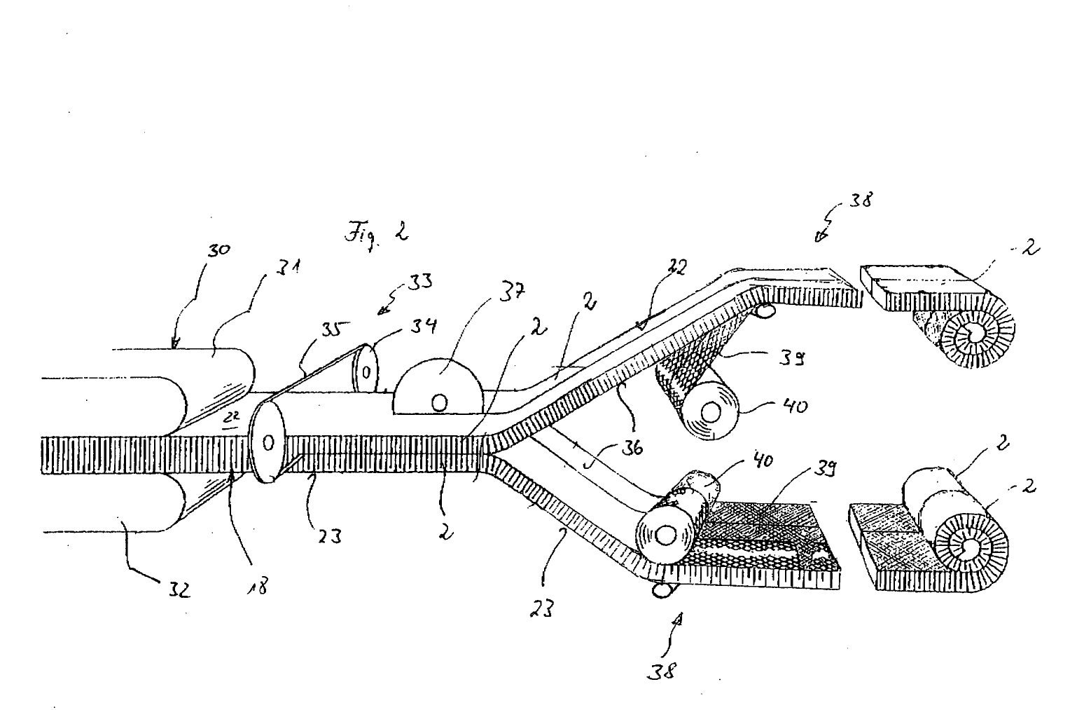

FIG. 2 a second section of a schematically illustrated device for the production of a web of insulating material from mineral fibres according to FIG. 1.

FIG. 1 shows the first section of a device 1 for the production of a web of insulating material 2 (FIG. 2) from mineral fibres 3. Said mineral fibres 3 are produced from a siliceous material, for example natural and/or artificial stones, by melting said siliceous material in a cupola furnace 4 and supplying the melt 5 to a defibring unit 6. Said defibring unit 6 includes several rotating spinning wheels 7, of which only one spinning wheel 7 is shown in FIG. 1.

The cupola furnace 4 includes a delivery channel 8, through which the melt 5 flows from the cupola furnace 4 onto the spinning wheels 7.

By the rotational movement of said spinning wheels 7 said mineral fibres 3 are formed from said melt 4 and are collected on a first conveyor 9. On this first conveyor 9 a primary non-woven material 10 is formed, in which the mineral fibres 3 that have been impregnated with bonding agents in said defibring unit 6 are arranged substantially in the same direction and in a similar fashion. Said primary non-woven material 10 is immediately passed to a downstream processing station 12 through a second conveyor 11 which differently from the first conveyor 9 is not a collecting conveyor, but a transport conveyor.

In the processing station 12 the general transport direction of the primary nonwoven material 10 is changed. This change takes place from the original longitudinal direction to a transport in the original transverse direction of said primary non-woven material 10. The conveying direction is shown in FIG. 1 by an arrow 13.

The primary non-woven material 10 is transported over a roller 14 which function is changing the transport direction of the primary non-woven material 10 from a substantially horizontal direction to a substantially vertical direction, in order to supply said primary non-woven material 10 to a further processing station 15. This further processing station 15 includes two mutually parallel arranged conveyor belts 16, 17, with the primary non-woven material 10 being guided between them. Said conveyor belts 16, 16 are arranged in an oscillating fashion and dangle said primary non-woven material 10 at right angles to its longitudinal extension into a secondary non-woven material 18 on further conveyor device which is not further shown and which extends parallel to the conveyor belts 9 and 11.

Said secondary non-woven material 18 dangled in this way is immediately supplied to a compacting station 19 where said secondary non-woven material 18 is compressed. Said compacting station 19 includes an upper conveyor belt 20 and a lower conveyor belt 21, with the secondary non-woven material 18 passing between them. Said two conveyor belts 20 and 21 of the compacting station 19 are arranged in an oscillating fashion and have in addition to the function of compressing said secondary non-woven material 18 also the function of dangling said secondary non-woven material 18 in a meandering fashion. This dangling of said secondary non-woven material 18 leads to that the secondary non-woven material 18 includes in its central part an orientation of the mineral fibres 3 which is at right angles to the large surfaces 22, 23. In zones directly below said large surfaces 22, 23 said secondary non-woven material 18 exhibits an orientation of the mineral fibres 3 which varies while deviating under an angle from the orthogonal axis to the large surfaces 22, 23 and up to a parallel orientation relative to said large surfaces 22, 23. This arrangement and orientation of the mineral fibres 3 in the secondary non-woven material 13 results from the dangling of the secondary non-woven material 18 subsequently to the compacting station 19.

The dangled secondary non-woven material 18 is fed to a processing station 24 directly after the dangling operation, which processing station 24 includes an upper conveyor belt 25 and a lower conveyor belt 26, of which the conveying speeds are lower compared to the conveying speed of the compacting station 19, so that the dangled secondary non-woven material 18 is compressed in the longitudinal direction thereof and the individual meanders of the dangled secondary non-woven material 18 are pushed together.

The processing station 24 is followed by a further downstream processing station 27 which also includes an upper conveyor belt 28 and a lower conveyor belt 29, with the dangled secondary non-woven material 18 being conveyed between them. Said processing station 27 has a further reduced conveying speed of the secondary non-woven material 18, in order to continue the compaction and homogenization of the dangled secondary non-woven material 18.

The secondary non-woven material 18 that has been prepared in this way forms a final product which can be further processed for example for forming particular webs of insulating material 2 from mineral fibres like e.g. insulation boards or insulation webs 2 as it is further described in the following with reference to FIG. 2.

The secondary non-woven material 18 that has been folded in a meandering fashion and compressed is supplied to a hardening furnace 30 by having arranged two mutually parallel extending conveyor belts 31 and 32. In said hardening furnace 30 hot air is passed through said conveyor belts 31, 32 and consequently also through said secondary non-woven material 18, whereby the bonding agent contained in said secondary non-woven material 18 for the connection of the single mineral fibres 3 is hardened by this hot air. Through the hardening of the bonding agent said secondary non-woven material 18 is fixed in its geometrical shape that has been given to it by the processing stations 12, 15, 19 and 24 as well as 27 before the hardening furnace.

The distance between the two conveyor belts 31, 32 in the hardening furnace 30 is set to the material thickness of the secondary non-woven material 18 and is limited by the conveying speed of the conveyor belts 31, 32 in proportion to the amount of hot air required for hardening the bonding agent.

After the hardening furnace 30 said secondary non-woven material 18 passes through a first sawing station 33 which includes a belt saw 34 with a belt-like saw blade 35, by means of which said secondary non-woven material 18 is divided by a separating cut parallel to the large surfaces 22, 23 into two webs of insulating material 2 which respectively have a large surface 22, 23 and a separating surface 36 which is substantially equal in area and opposite the respective large surface 22, 23.

Said secondary non-woven material 18 which as a width of 2,400 mm is thereafter divided into four partial webs in the longitudinal direction thereof by means of a circular saw including a circular saw blade 37, each of said partial webs finally representing a web of insulating material 2 and having a width of 1,200 m.

The webs of insulating material 22 that have been separated in the longitudinal direction by the separating cut parallel to the large surfaces 22, 23 of the secondary non-woven material 18 are lifted off from each other and are fed to a lamination station 38 where a lamination 39 is applied to the separating surfaces 36 of the web of insulating material 2. To this end, said lamination 39 is kept as a supply in the form of a lamination roll 40 for each web of insulating material 2, said lamination 39 being drawn off said lamination roll 40 along with the transport of the web of insulating material 2 and being bonded equal in area to the web of insulating material 2. After said lamination stations 38 said webs of insulating material 2 are rolled up and packed. To this end, said webs of insulating material 2 are cut into a predetermined length from the secondary non-woven material 18 by making a cut a right angles to the longitudinal direction of the web of insulating material 2.

The lamination 39 is formed as an air-permeable and heat-resistant non-woven material from glass fibres and forms an external reinforcement, protection, filter and decorative layer. The connection of the lamination 39 to the web of insulating material 2 in the lamination station 38 takes place by means of highly viscous dispersion binder that is sprayed onto the web of insulating material 2 over the full area, in a punctual or strip-like fashion, dependent on the required connection between the lamination 39 and the web of insulating material 2. The lamination 39 is arranged on the separating surface 36 of the web of insulating material 2, so that the lamination 39 is connected to the fibre tips of the fibre arranged at right angles to the separating surface 36 of the web of insulating material 2. Supplementary, it may me provided that prior to the rolling-up of the web of insulating material 2 the mineral fibres 3 present in the region of the large surfaces 22, 23 and deviating from an orientation at right angles to the large surfaces 22, 23 are removed by a cutting or grinding operation.

1. Method for the production of a web of insulating material made of mineral fibres, in particular from rock wool and/or glass wool, wherein the mineral fibres are made from a melt and are deposited onto a conveyor as a primary non-woven material the primary non-woven material is dangled at right angles in relation to the longitudinal extension thereof and is deposited as a secondary non-woven material onto a second conveyor, the secondary non-woven material is then displaced in such a way that the mineral fibres extend at right angles in relation to the large surfaces of the secondary non-woven material and the secondary non-woven material is subsequently divided into at least two webs of insulating material by means of a separating cut parallel to the large surfaces of the secondary non-woven material, said webs of material respectively comprising a large surface and a separating surface which has substantially the same area as the large surface and which is arranged opposite said large surface,
characterized in that a lamination (39) is applied to at least one of the separating surfaces (36) of said two webs of insulating material (2).

2. Method according to claim 1,
characterized in that the mineral fibres (3) which in said large surfaces (22, 23) extend substantially parallel to said large surfaces (22, 23) are removed.

3. Method according to claim 1,
characterized in that said webs of insulating material (2) are fed to a hardening furnace (30) before and/or after the applying of the lamination (39), in which hardening furnace (30) a bonding agent already contained in the primary non-woven material (10) is hardened.

4. Method according to claim 1,
characterized in that the separating cut for forming the webs of insulating material (2) is made centrally between the said large surfaces (22, 23) of the secondary non-woven material (18).

5. Method according to claim 1,
characterized in that said lamination (39) is applied as an air-permeable and/or heat-resistant non-woven, woven or two-dimensional structure, in particular from glass and/or natural fibres or organic chemical fibres like e.g. from carbon, aramide, terephthalate, polyamide, polypropylene or mixtures thereof or as a foil for example an aluminum-polyethylene composite foil, and at least in one layer and particularly in the form of tension-resistant webs.

6. Method according to claim 1,
characterized in that the lamination (39) is applied in several layers, said layers of the lamination (39) being preferably formed differently from each other.

7. Method according to claim 6,
characterized in that the layers of the lamination (39) made of a glass fibre tangled web are connected to layers made of tangled webs from thermoplastic fibres and/or perforated foils from thermoplastic materials.

8. Method according to claim 1,
characterized in that said lamination (39) is bonded to the web of insulating material (2), wherein said bonding is preferably effected over a partial area, particularly in the form of lines or dots, and wherein for example heat-sealing adhesives are used.

9. Method according to claim 1,
characterized in that said lamination (39) is formed as an external reinforcement, protection, filter and/or decorative layer.

10. Method according to claim 1,
characterized in that said lamination (39) is drawn off a roll (40) and is fed together with the web of insulating material (2) to a processing station (38), where said lamination (39) is connected to said web of insulating material (2).

11. Method according to claim 10,
characterized in that several layers of said lamination (39) are drawn off a roll (40).

12. Method according to claim 1,
characterized in that bonding agents present in said web of insulating material (2) are activated by means of solvents like for example water, prior to being connected to the lamination (39).

13. Method according to claim 12,
characterized in that the activation of said bonding agents is effected by means of contact rollers.

14. Method according to claim 1,
characterized in that said bonding agent is sprayed onto the separating surface (36) of the web of insulating material (2), prior to applying the lamination (39).

15. Method according to claim 1,
characterized in that between said web of insulating material (2) and said lamination (39) a layer of an impregnation, particularly made of a highly viscous dispersion binder or a pigment-filled water-silicate synthetic binder is arranged.

16. Method according to claim 1,
characterized in said impregnation is applied at a high viscosity, so that said impregnation is not absorbed by said lamination (39).

17. Method according to claim 1,
characterized in that said two webs of insulating material (2) are brought together after the application of the laminations (39) and together are supplied to a hardening furnace (30).

18. Method according to claim 17,
characterized in that said webs of insulating material (2) after leaving said hardening furnace (30) are trimmed in the longitudinal direction thereof, are cut to length and are rolled up or divided into single insulation boards and supplied to a packaging station.

19. Method according to claim 1,
characterized in that mineral fibre dust occurring during the separation of the secondary non-woven material (18) into webs of insulating material (2) are removed and particularly exhausted prior to the application of the lamination (39).

20. Method according to claim 5,
characterized in that said foil is reinforced by a two dimensional glass-fibre netting.

21. Method according to claim 5,
characterized in that said aluminum-polyethylene composite foil is heated in such a way that the polyethylene layer is softened and becomes welded to the mineral fibre tips of the web of insulating material (2).

22. Method according to claim 1,
characterized in that said lamination (39) is formed of different layers.

23. Method according to claim 1,
characterized in that the lamination (39) is formed larger in area than said separating surface (36), so that said lamination (39) projects especially over at least one longitudinal side of said web of insulating material (2).

24. Method according to claim 1,
characterized in that markings are arranged on said lamination (39) which serve for cutting said web of insulating material (2) to length.

25. Web of insulating material made of mineral fibres bound with at least one bonding agent, particularly from mineral wool and/or glass wool, comprising a large surface and a separating surface that is formed at the division of a secondary non-woven material into two webs of insulating material, wherein said mineral fibres in the region of said separating surface are arranged to extend at right angles to the separating surface and in the region of the surface deviating under an angle of 90° in relation to the large surface, in particular parallel to the large surface, and comprising a lamination,
characterized in that said lamination (39) is arranged on the separating surface (36).

26. Web of insulating material according to claim 25,
characterized in that said lamination (39) is formed as an air-permeable and/or heat-resistant non-woven, woven or two-dimensional structure, in particular from glass and/or natural fibres or organic chemical fibres like e.g. from carbon, aramide, terephthalate, polyamide, polypropylene or mixtures thereof or as a foil, for example an aluminum-polyethylene composite foil, and at least in one layer and particularly in the form of tension-resistant webs.

27. Web of insulating material according to claim 25,
characterized in that said lamination (39) is formed in several layers, with said layers of said lamination being preferably formed differently from each other.

28. Web of insulating material according to claim 25,
characterized in that said layers of the lamination (39) made of a glass fibre tangled web are connected to layers made of tangled webs from thermoplastic fibres and/or perforated foils from thermoplastic materials.

29. Web of insulating material according to claim 25,
characterized in that said lamination (39) is bonded to the web of insulating material (2), wherein said bonding is preferably effected over a partial area, particularly in the form of lines or dots, and for example with a heat-sealing adhesive.

30. Web of insulating material according to claim 25,
characterized in that said lamination (39) is formed as an external reinforcement, protection, filter and/or decorative layer.

31. Web of insulating material according to claim 25,
characterized in that between said web of insulating material (2) and said lamination (39) a layer of an impregnation, particularly made of a highly viscous dispersion binder or a pigment-filled water-silicate synthetic binder is arranged.

32. Web of insulating material according to claim 25,
characterized in that the impregnation has a high viscosity, so that the impregnation is not absorbed by the lamination (39).

33. Web of insulating material according to claim 26.
characterized in that the foil is reinforced by a two-dimensional glass-fibre netting.

34. Web of insulating material according to claim 25,
characterized in that said lamination (39) is formed of different layers.

35. Web of insulating material according to claim 25,
characterized in that said lamination (39) is formed larger in area than said separating surface (36), so that said lamination (39) especially projects over at least one longitudinal side of said web of insulating material (2).

36. Web of insulating material according to claim 25,
characterized in that markings are arranged on said lamination (39) which serve for cutting said web of insulating material (2) to length.
